(19) United States
(12) Patent Application Publication
(10) Pub. No.: US 2004/0218848 A1
(43) Pub. Date: Nov. 4, 2004

(54) Flexible electronic/optical interconnection film assembly and method for manufacturing

(75) Inventors: Lee-Cheng Shen, Hsinchu (TW); Yu-Chih Chen, Ilan (TW); Shu-Ming Chang, Tucheng City (TW); Chih-Hsiang Ko, Nan Chiu (TW)

Correspondence Address: TUNG & ASSOCIATES, Suite 120, 838 W. Long Lake Road, Bloomfield Hills, MI, 48302, US

(73) Assignee: Industrial Technology Research Institute

(21) Appl. No.: 10/427,449

(22) Filed: Apr. 30, 2003

(51) Int. Cl. G02B 6/12

(52) U.S. Cl. 385/14

(57) ABSTRACT

A flexible electronic/optical interconnection film assembly which includes a flexible waveguide film laminated to a flexible electrical film, such as a flexible PCB. The flexible waveguide film has embedded internal waveguide capable of total internal reflection such that optical transmission between two IC elements can be achieved through the use of laser diode transmitters and photodetector receivers. A flexible electrical film that is laminated to the flexible waveguide film may have a plurality of metal interconnect lines formed therein for providing electrical communication. A thin metal trace layer and a plurality of conductive pads which are formed from the thin metal trace layer may be formed on top of the flexible waveguide film for providing electrical communication with active opto-electronic devices mounted on top of the flexible waveguide film.

### FIELD OF THE INVENTION

The present invention generally relates to an electronic/optical interconnection assembly and method for manufacturing and more particularly, relates to a flexible electronic/optical interconnection film assembly suitable for high-speed data transmission and low cost manufacturing and method for manufacturing.

### BACKGROUND OF THE INVENTION

In the recent trend of development of high-speed, wideband opto-electronic (or electronic-optical) data transmission devices, electronic-optical circuit board (EOCB) has been developed to combine the functions for electronic signal transmission and for optical signal transmission. In current development, a most common trend is to mount a waveguide device and optical transmission/receiving devices on a conventional printed circuit board (PCB) fabricated of a rigid material. The optical transmission/receiving devices may be suitably of the laser diode type and the photodetector type. However, difficulties involved in the manufacturing process and the cost of the materials are significantly increased due to an increase in the substrate area, which further reduces significantly the yield of the process. These drawbacks lead to a severe limitation on the dimensions of the device substrate that can be utilized, i.e. only small-dimensioned EOCB can be fabricated by the present technology.

Another limitation in the present technology for fabricating EOCB by using a conventional printed circuit board is the optical transmission in the electronic-optical system. The interconnection between circuit elements in the system or the interconnection between the system and a module are only limited to the utilization of passive-type optical transmission medium. When conventional printed circuit board is used in applications involving high-speed optical transmission, the circuit must be modified to increase its opto-electronic elements. As a result, the equipment cost and the manufacturing cost are greatly increased. The development of an active electronic-optical conversion and transmission capability that is compatible with the present printed circuit board technology in order to interface with the present structure is very important. It is therefore desirable to provide a flexible electronic-optical interconnection film assembly that can be used in large-dimensioned substrates for forming high-speed devices and for the 3-dimensional stacked modular assembly. The flexible electronic-optical interconnection film assembly can further reduce the fabrication cost for the opto-electronic system and further reduce the dimension of the assembly.

FIG. 1A is a perspective view of a conventional assembly 10 formed by utilizing electrical bus 12 interconnecting two modules 14 and 16 together on a conventional printed circuit board 18. The electrical bus 12, i.e. the metal transmission line, is also shown in a cross-sectional view in FIG. 1B.

In another conventional assembly 20, shown in FIG. 2A, the two modules 14 and 16 are connected by a flexible active optical parallel bus 22 on a conventional printed circuit board 18. Shown in more detail in a cross-sectional view in FIG. 2B, active optical/electronic devices 24,26 such as laser diodes and photodetectors are used to provide a flexible optical/electronic path for the parallel bus 22.

It is therefore an object of the present invention to provide an electronic/optical interconnection film assembly that does not have the drawbacks or shortcomings of the conventional systems.

It is another object of the present invention to provide a flexible electronic/optical interconnection film assembly capable of high-speed optical data transmission.

It is a further object of the present invention to provide a flexible electronic/optical interconnection film assembly that is capable of wideband signal transmissions.

It is another further object of the present invention to provide a flexible electronic/optical interconnection film assembly that can be expanded from a 2-dimensional to a 3-dimensional assembly.

It is still another object of the present invention to provide a flexible electronic/optical interconnection film assembly that performs active opto-electronic transmission in both inter and intra-systems.

It is yet another object of the present invention to provide a method for fabricating a flexible electronic/optical interconnection film assembly by laminating a flexible electrical film to a flexible waveguide film.

### SUMMARY OF THE INVENTION

In accordance with the present invention, a flexible electronic/optical interconnection film assembly and a method for fabricating the assembly are provided.

In a preferred embodiment, a flexible electronic/optical interconnection film assembly that includes a flexible waveguide film including at least one embedded internal waveguide that has total internal reflection characteristics, a top surface and a bottom surface; a flexible electrical film laminated to the bottom surface of the flexible waveguide film including a plurality of metal interconnect lines therein for providing electrical communication; a flexible metal trace layer and a plurality of conductive pads formed on the top surface of the flexible waveguide film; and a plurality of active electronic devices mounted on top of the metal trace layer and electrically connected to the plurality of conductive pads.

In the flexible electronic/optical interconnection film assembly, the flexible waveguide film is formed by two cladding layers sandwiching a core layer therein-between. The core layer may be formed of a material capable of producing total internal reflection characteristics. The core layer may be formed of a material selected from the group consisting of polyimide, PMMA and epoxy. The flexible electrical film may be formed of an electrically insulating material with electrically conductive lines embedded therein. The flexible metal trace layer may have a thickness not more than 100 μm. The flexible electrical film may have a bottom surface that is not laminated to the flexible waveguide film, the bottom surface may include a multiplicity of solder bumps for providing electrical communication to external circuits. The plurality of active electronic devices may be selected from a group consisting of driver IC chips, amplifier chips, application specific IC chips, laser diode chips and photodetector chips. The total internal reflection characteristics of the waveguide film may be provided by a pair of 45°-angled reflection surfaces.

The present invention is further directed to a method for fabricating a flexible electronic/optical interconnection film assembly which can be carried out by the operating steps of providing a flexible waveguide film that includes at least one embedded internal waveguide that has total internal reflection characteristics, the flexible waveguide film may further have a top surface and a bottom surface; laminating a flexible electrical film to the bottom surface of the flexible waveguide film, the flexible electrical film may include a plurality of metal interconnect lines therein for providing electrical communication; forming a flexible metal trace layer and a plurality of conductive pads on the top surface of the flexible waveguide film; and mounting a plurality of active electronic devices on top of the metal trace layer and forming electrical connections to the plurality of conductive pads.

The method for fabricating a flexible electronic/optical interconnection film assembly may further include the step of forming the flexible waveguide film by two cladding layers and a core layer sandwiched therein-between, or the step of forming the core layer in the flexible waveguide film of a material capable of producing total internal reflection characteristics, or the step of forming the core layer by a material selected from the group consisting of polyimide, PMMA and epoxy. The method may further include the step of forming the flexible electrical film of an electrically insulating material, or the step of forming the flexible metal trace layer to a thickness not more than 100 μm, or the step of forming a multiplicity of solder bumps on a bottom surface of the flexible electrical film that is not laminated to the flexible waveguide film for providing electrical connections to external circuits.

The method may further include the step of selecting the plurality of active electronic devices from a group consisting of driver IC chips, amplifier chips, application specific IC chips, laser diode chips and photodetector chips. The method may further include the step of forming in the embedded internal waveguide in the flexible waveguide film a pair of 45°-angled reflection surfaces.

### BRIEF DESCRIPTION OF THE DRAWINGS

These and other objects, features and advantages of the present invention will become apparent from the following detailed description and the appended drawings in which:

FIG. 1A is a perspective view of an electrical bus connecting two modules formed on a conventional printed circuit board.

FIG. 1B is a cross-sectional view of the conventional PCB assembly shown in FIG. 1A.

FIG. 2A is a perspective view of a flexible active optical parallel bus connecting two modules formed on a conventional printed circuit board.

FIG. 2B is a cross-sectional view of the conventional PCB assembly shown in FIG. 2A.

FIG. 3A is a perspective view of the present invention flexible optical waveguide connecting two modules formed on a flexible electrical film.

FIG. 3B is a cross-sectional view of the present invention flexible optical waveguide/flexible electrical film assembly of FIG. 3A.

FIG. 4A is a cross-sectional view of the present invention flexible waveguide film provided on a carrier.

FIG. 4B is a cross-sectional view of the flexible waveguide film of FIG. 4A with a metal thin film deposited on top and the carrier film separated.

FIG. 4C is a cross-sectional view of the present invention flexible waveguide film of FIG. 4B with a pair of 45°-angled reflection surfaces formed for achieving a total internal reflection process.

FIG. 4D is a cross-sectional view of the present invention flexible waveguide film positioned on top of a flexible electrical film.

FIG. 4E is a cross-sectional view of the present invention flexible waveguide film and the flexible electrical film laminated together with a plurality of active devices mounted on top of the flexible waveguide film.

FIG. 5A is a top view of the present invention assembly of FIG. 4E.

FIG. 5B is a cross-sectional view of the present invention flexible electronic/optical interconnection film assembly of FIG. 5A.

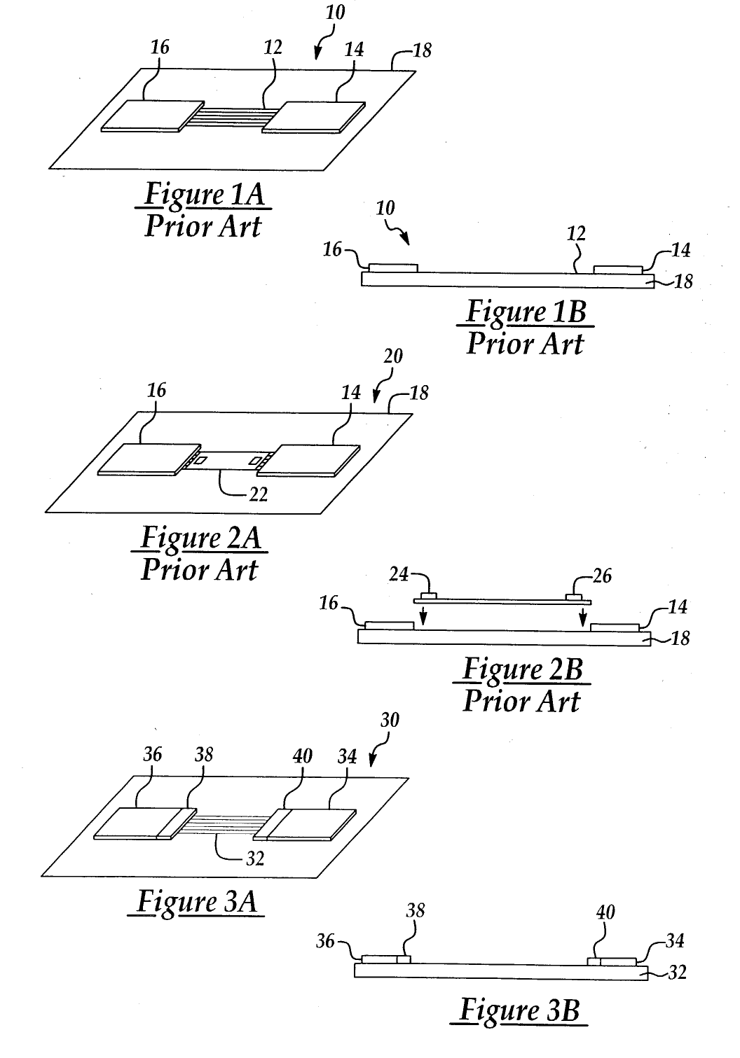

### DETAILED DESCRIPTION OF THE PREFERRED EMBODIMENT

The present invention discloses a flexible electronic/optical interconnection film assembly which is assembled together by a flexible waveguide film and a flexible electrical film. The assembly is capable of transmitting optical signals and wideband opto-electronic signals at low cost. The assembly is capable of being arranged in a 3-dimensional manner achieving optical interconnection at low noise levels.

The present invention flexible electronic/optical interconnection film assembly provides an embedded opto-electronic integrated bus for high-speed and wideband data transmission wherein high-speed data (i.e. >1 GHz) may be transmitted by optical means and low-speed signal (i.e. 500 MHZ ˜1 GHz) may be transmitted by electrical means. The flexible electronic/optical interconnection film assembly may be in a modular form or in a surface mounted assembly form. By using the present invention modular high-speed optical transmission, various sub-systems on a printed circuit board may be connected by a 3-dimensional flexible opto-electronic integrated bus. The invention therefore solves the complexity of present hard substrate optical electronic connections fabrication process and the lack of rework capability problems. The total space required for the 3-dimensional flexible interconnection system is further reduced by utilizing the smaller area for an opto-electronic integrated bus assembly.

Numerous benefits or advantages of the present invention can be realized by utilizing the flexible electronic/optical interconnection film assembly. For instance, the optical waveguide and the electrical bus lines may be assembled together to form an optical/electronic integrated bus. The flexible feature of the present invention interconnection film assembly enables a 3-dimensional stacking of the opto-electronic module and furthermore, facilitates signal transmission and interconnection between various sub-systems while saving space occupied. The flexible interconnection film assembly actively performs electronic/optical data transition and transport between modules such that the opto-electronic interface of the present system can be simplified and expanded. The cost for integrating electronic/optical data transmission may also be reduced. A substrate may be used in the present invention assembly for mounting and interconnecting active and passive elements together. By utilizing the present invention interconnection assembly, the conventional fabrication process for printed circuit boards can be used without significant modification and thus, simplifying the electronic/optical integration task.

Referring initially to FIG. 3A, wherein a present invention flexible electronic/optical interconnection film assembly 30 is shown. The assembly 30 is formed by utilizing a flexible optical waveguide film 32 to connect two modules 34,36 together forming an electronic-optical circuit board. A cross-sectional view of the electronic-optical circuit board 30 is shown in FIG. 3B. It should be noted that the active opto-electronic devices 38,40 are integrated into the modules 34,36, respectively. Typical active opto-electronic devices are laser diodes for transmission of optical signals and photodetectors for receiving optical signals.

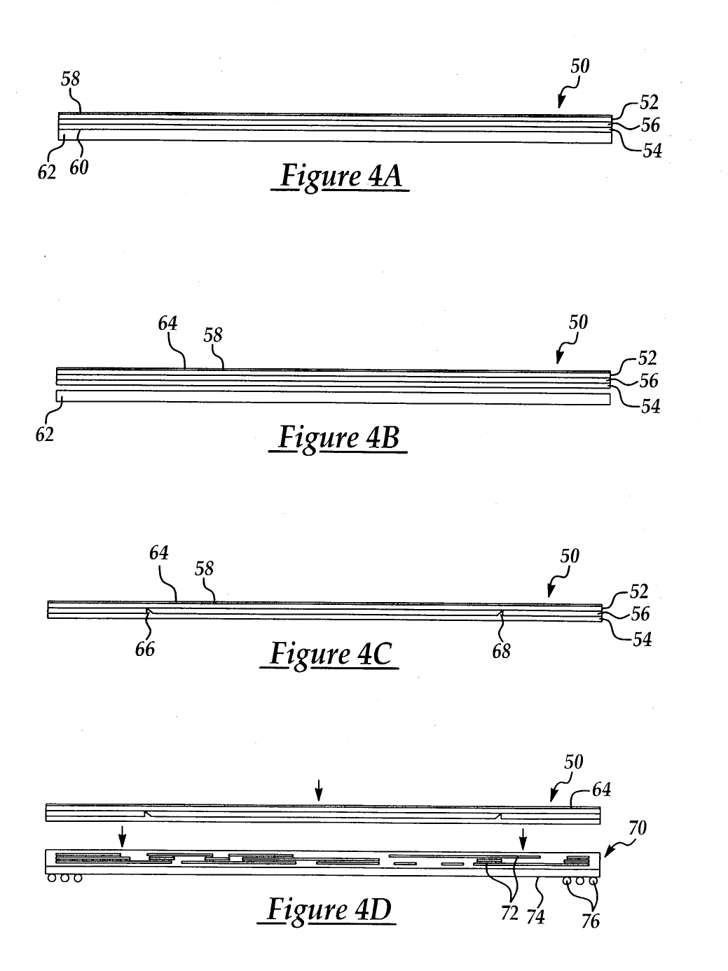

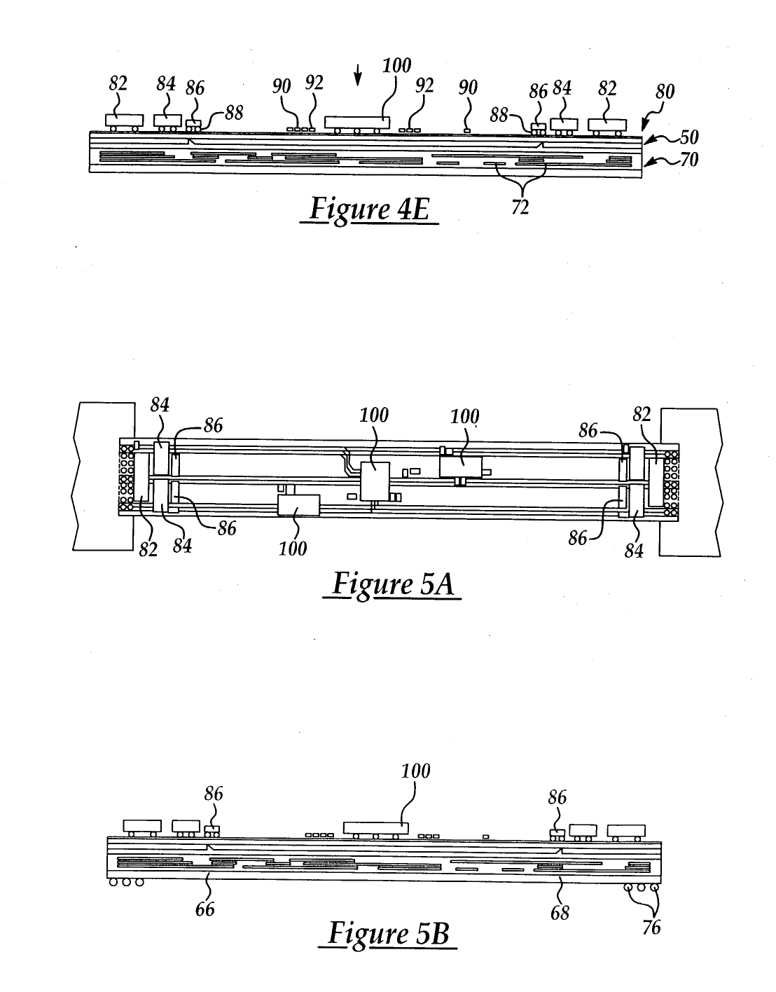

The fabrication process for the present invention flexible electronic/optical interconnection film assembly can be carried out by first providing a flexible waveguide film 50, as shown in FIG. 4A, which includes at least one embedded internal waveguide that has total internal reflection (TIR) capability. The flexible waveguide film 50 is formed by two cladding layers 52, 54 sandwiching a core layer 56. The core layer 56 is formed of a material that is capable of producing total internal reflection characteristics, and is normally formed by a material selected from the group consisting of polyimide, PMMA and epoxy. The flexible waveguide film 50 has a top surface 58 and a bottom surface 60 which is supported by a carrier film 62.

In the next step of the process, the carrier film 62 is stripped of and separated from the flexible waveguide film 50. The flexible waveguide film 50 is further deposited on the top surface 58 a metal thin film 64 for forming metal traces and for forming a plurality of conductive pads (not shown) in a future process. The metal thin film 64 may be advantageously deposited by a process such as sputtering from an electrically conductive metal such as aluminum, copper, nickel or any other suitable metals.

A pair of 45°-angled surfaces 66 and 68 are then formed in the core layer 56 to provide the function of total internal reflection for active opto-electronic devices later mounted on top of the waveguide film 50.

A flexible electrical film 70 is then provided which contains embedded therein a plurality of electrical interconnect lines 72. This is shown in FIG. 4D. The flexible electrical film 70 is formed of an insulating material such that the plurality of interconnect lines 72 are insulated against each other. A bottom surface 74 of the flexible electrical film 70 is further provided with a plurality of solder bumps, i.e. or solder balls 76, to facilitate electrical connection to external circuits. The flexible electrical film 70 is then laminated to the flexible waveguide film 50 forming an assembly 80, as shown in FIG. 4E. After the lamination process, a plurality of active opto-electronic devices such as application specific integrated circuit chips 82, amplifier/driver IC 84, laser diode/photodetector 86, are connected to the plurality of conductive pads (not shown) formed by the metal trace layer 64 by solder balls 88. A number of other electrical components such as capacitors 90 and resistors 92, and active devices 100 which may be connected as a flip-chip or as a surface mount package to the flexible waveguide film 50.

A top view of the flexible electronic/optical interconnection film assembly 80 is also shown in FIG. 5A and a cross-sectional view is shown in FIG. 5B. It is seen in FIG. 5B that, the pair of active opto-electronic devices 86 of a laser diode and a photodetector are each paired with a 45°-angled reflecting surfaces 66 and 68 to achieve the total internal reflection process. It should be noted that the flexible electrical film 70 can be a flexible printed circuit board.

The present invention utilizes ASIC (application specific integrated circuit) chips for front-end processing of electronic signals from an IC chip or a module such that signals from the I/O pins of read or write can be de-serialized or serialized. A driver IC chip is then used to modulate the electronic signal in order to drive a laser diode for emitting laser emission. The emitted laser signal is sent through the flexible waveguide film and reflected by the 45°-angled reflection surface into a photodetector. The laser emission enters the photodetector for transforming to an electronic signal, which is then amplified by the amplifier and demodulized to a compatible electronic signal. When two sets of laser diode/photodetectors are used, a dual directional transmission system can be achieved.

The present invention flexible electronic/optical interconnection film assembly and a method for fabricating the film assembly have therefore been amply described in the above description and in the appended drawings of FIGS. 3A-5B.

While the present invention has been described in an illustrative manner, it should be understood that the terminology used is intended to be in a nature of words of description rather than of limitation.

Furthermore, while the present invention has been described in terms of a preferred embodiment, it is to be appreciated that those skilled in the art will readily apply these teachings to other possible variations of the inventions.

The embodiment of the invention in which an exclusive property or privilege is claimed are defined as follows.

What is claimed is:

1. A flexible electronic/optical interconnection film assembly comprising:
a flexible waveguide film comprising at least one embedded internal waveguide having total internal reflection characteristics, a top surface and a bottom surface;
a flexible electrical film laminated to said bottom surface of said flexible waveguide film comprising a plurality of metal interconnect lines therein for providing electrical communication;
a flexible metal trace layer and a plurality of conductive pads formed on said top surface of the flexible waveguide film; and
a plurality of active electronic devices mounted on top of said metal trace layer and electrically connected to said plurality of conductive pads.

2. A flexible electronic/optical interconnection film assembly according to claim 1, wherein said flexible waveguide film being formed by two cladding layers sandwiching a core layer therein-between.

3. A flexible electronic/optical interconnection film assembly according to claim 2, wherein said core layer being formed of a material capable of producing total internal reflection characteristics.

4. A flexible electronic/optical interconnection film assembly according to claim 2, wherein said core layer being formed of a material selected from the group consisting of polyimide, PMMA and epoxy.

5. A flexible electronic/optical interconnection film assembly according to claim 1, wherein said flexible electrical film being formed of an electrically insulating material.

6. A flexible electronic/optical interconnection film assembly according to claim 1, wherein said flexible metal trace layer having a thickness not more than 100 μm.

7. A flexible electronic/optical interconnection film assembly according to claim 1, wherein said flexible electrical film having a bottom surface that is not laminated to said flexible waveguide film, said bottom surface comprises a multiplicity of solder bumps for providing electrical connections to external circuits.

8. A flexible electronic/optical interconnection film assembly according to claim 1, wherein said plurality of active electronic devices being selected from a group consisting of driver IC chips, amplifier chips, application specific IC chips, laser diode chips and photodetector chips.

9. A flexible electronic/optical interconnection film assembly according to claim 1, wherein said total internal reflection characteristics being provided by a pair of 45°-angled reflection surfaces.

10. A method for fabricating a flexible electronic/optical interconnection film assembly comprising the steps of:
providing a flexible waveguide film comprising at least one embedded internal waveguide having total internal reflection characteristics, said flexible waveguide film further having a top surface and a bottom surface;
laminating a flexible electrical film to said bottom surface of the flexible waveguide film, said flexible electrical film comprising a plurality of metal interconnect lines therein for providing electrical communication;
forming a flexible metal trace layer and a plurality of conductive pads on said top surface of the flexible waveguide film; and
mounting a plurality of active electronic devices on top of said metal trace layer and forming electrical connections to said plurality of conductive pads.

11. A method for fabricating a flexible electronic/optical interconnection film assembly according to claim 10 further comprising the step of forming said flexible waveguide film by two cladding layers and a core layer sandwiched therein-between.

12. A method for fabricating a flexible electronic/optical interconnection film assembly according to claim 11 further comprising the step of forming said core layer in said flexible waveguide film of a material capable of producing total internal reflection characteristics.

13. A method for fabricating a flexible electronic/optical interconnection film assembly according to claim 11 further comprising the step of forming said core layer in said flexible waveguide film by a material selected from the group consisting of polyimide, PMMA and epoxy.

14. A method for fabricating a flexible electronic/optical interconnection film assembly according to claim 10 further comprising the step of forming said flexible electrical film of an electrically insulating material.

15. A method for fabricating a flexible electronic/optical interconnection film assembly according to claim 10 further comprising the step of forming said flexible metal trace layer to a thickness not more than 100 μm.

16. A method for fabricating a flexible electronic/optical interconnection film assembly according to claim 10 further comprising the step of forming a multiplicity of solder bumps on a bottom surface of said flexible electrical film that is not laminated to said flexible waveguide film for providing electrical connections to external circuits.

17. A method for fabricating a flexible electronic/optical interconnection film assembly according to claim 10 further comprising the step of selecting said plurality of active electronic devices from a group consisting of driver IC chips, amplifier chips, application specific IC chips, laser diode chips and photodetector chips.

18. A method for fabricating a flexible electronic/optical interconnection film assembly according to claim 10 further comprising the step of forming in said embedded internal waveguide in the flexible waveguide film a pair of 45°-angled reflection surfaces.
